(19) United States
(12) Patent Application Publication
(10) Pub. No.: US 2022/0226967 A1
(43) Pub. Date: Jul. 21, 2022

(54) Connector Tool Assembly

(71) Applicants: Jeremy Edmonds, Las Vegas, NV (US); Karen Solomon, Las Vegas, NV (US)

(72) Inventors: Jeremy Edmonds, Las Vegas, NV (US); Karen Solomon, Las Vegas, NV (US)

(21) Appl. No.: 17/153,933

(22) Filed: Jan. 21, 2021

(51) Int. Cl. B25B 7/10; B25B 7/02

(52) U.S. Cl. CPC B25B 7/10; B25B 7/02

(57) ABSTRACT

A connector tool assembly for compressing solar panel connectors together includes a pair of pliers and a pair of members that is each coupled to a jaw associated with a respective one of the pliers. A pair of grips is provided and each of the grips is coupled to a respective one of the members. Each of the grips has a slot extending therethrough to accommodate a conductor of a respective one of a pair of solar panel connectors having the solar panel connectors positioned between the grips. Each of the grips is urged toward each other when the pair of pliers is manipulated into a closed position. In this way each of the grips compresses the solar panel connectors into a connected condition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tool devices and more particularly pertains to a new tool device for compressing solar panel connectors together. The tool comprises a pair of pliers that has a pair of grips, each having a slot therein, for compressing a pair of solar panel connectors together.

### (2) Description of Related Art Including Information Disclosed Under 37 CFR 1.97 and 1.98

The prior art relates to tool devices including a variety of pliers that each has elongated elements coupled to respective jaws of the pliers. In each instance the elongated elements are structurally unique from each other. In no instance does the prior art disclose a pair of pliers that includes elongated elements being coupled to respective jaws of the pliers and a pair of grips that are coupled to respective elongated elements.

### BRIEF SUMMARY OF THE INVENTION

An embodiment of the disclosure meets the needs presented above by generally comprising a pair of pliers and a pair of members that is each coupled to a jaw associated with a respective one of the pliers. A pair of grips is provided and each of the grips is coupled to a respective one of the members. Each of the grips has a slot extending therethrough to accommodate a conductor of a respective one of a pair of solar panel connectors having the solar panel connectors positioned between the grips. Each of the grips is urged toward each other when the pair of pliers is manipulated into a closed position. In this way each of the grips compresses the solar panel connectors into a connected condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a connector tool assembly according to an embodiment of the disclosure.

FIG. 2 is a left side view of an embodiment of the disclosure.

FIG. 3 is a top view of an embodiment of the disclosure.

FIG. 4 is a front view of an embodiment of the disclosure.

FIG. 5 is a perspective in-use view of an embodiment of the disclosure showing a pair of solar panel connectors being unseated from each other.

FIG. 6 is a perspective in-use view of an embodiment of the disclosure showing a pair of solar panel connectors being seated with each other.

### DETAILED DESCRIPTION OF THE INVENTION

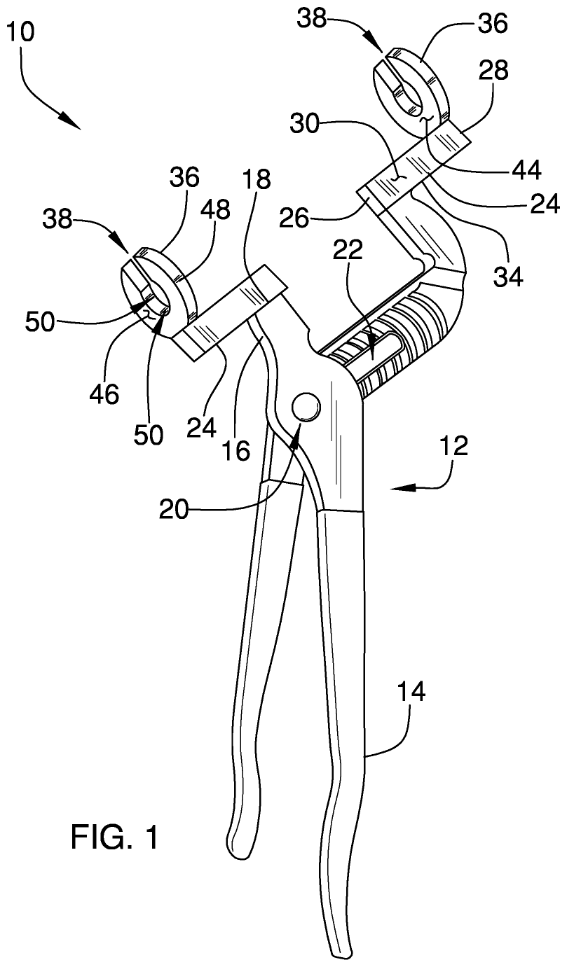

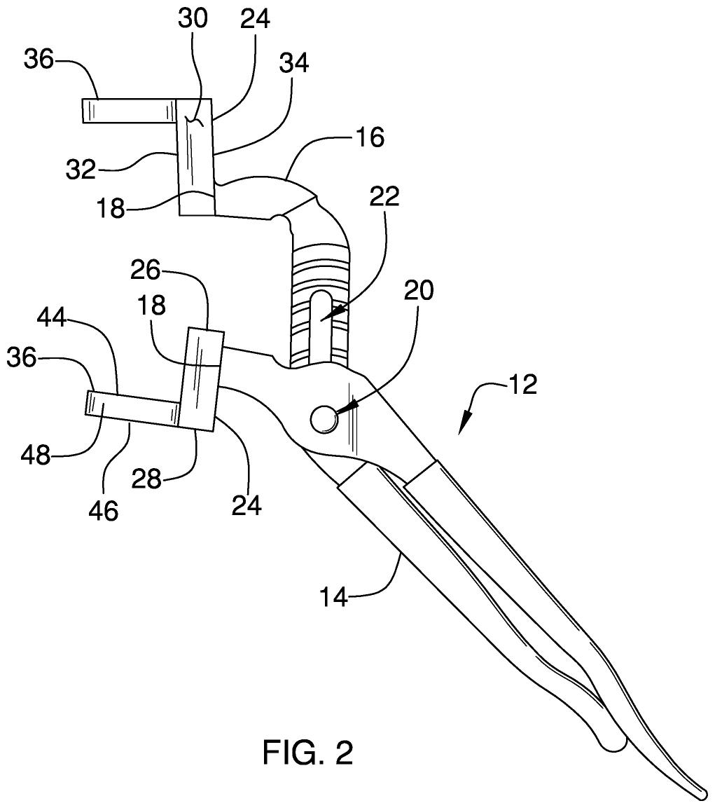

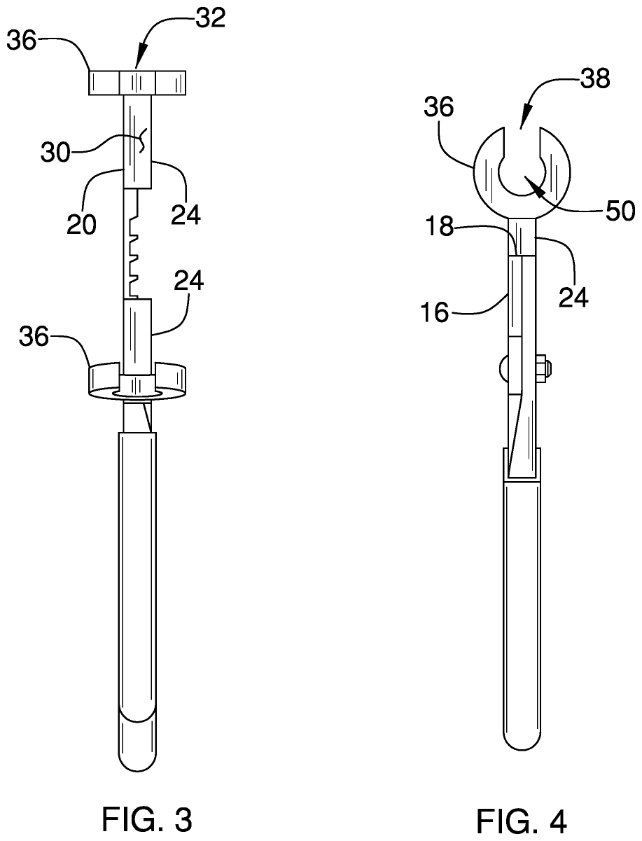

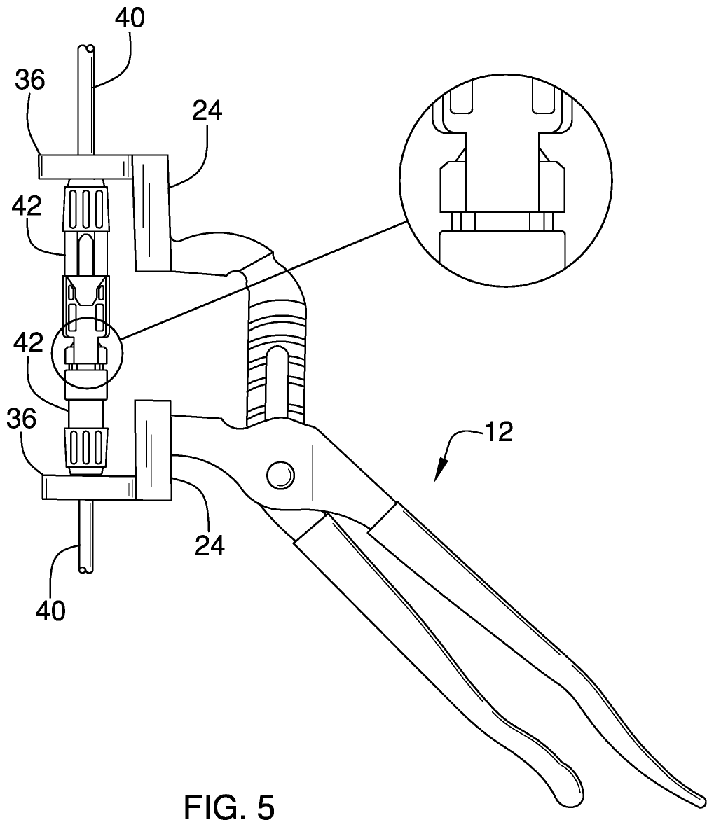

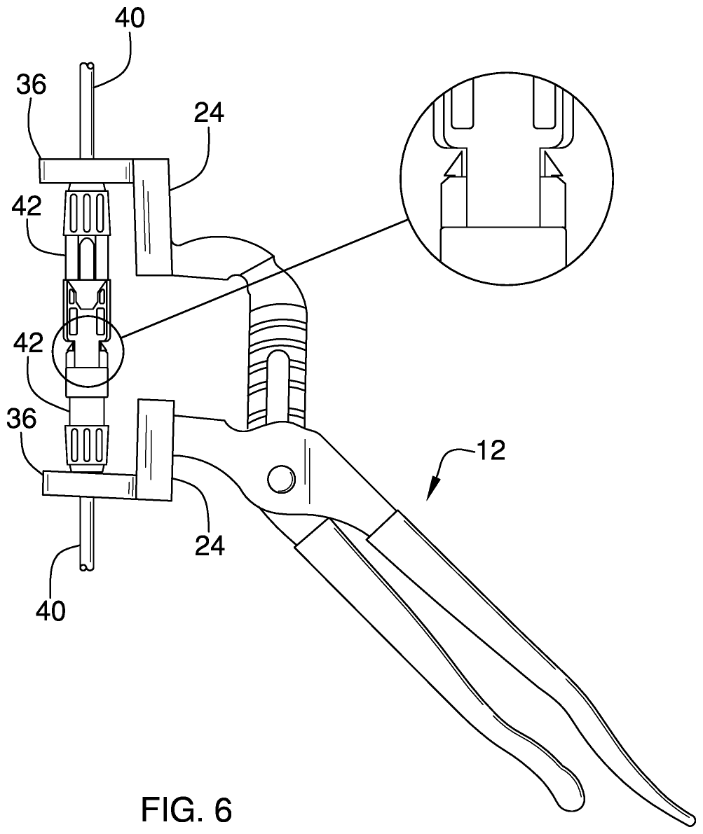

With reference now to the drawings, and in particular to FIGS. 1 through 6 thereof, a new tool device embodying the principles and concepts of an embodiment of the disclosure and generally designated by the reference numeral 10 will be described.

As best illustrated in FIGS. 1 through 6, the connector tool assembly 10 generally comprises a pair of pliers 12 that each comprises a handle 14 and a jaw 16, and the jaw 16 associated with each of the pliers 12 has a distal end 18. The handle 14 each of each of the pair of pliers 12 is pivotally coupled together at a pivot point 20. In this way the jaw 16 associated with each of the pair of pliers 12 can be urged toward or away from each other when the handle 14 of each of the pair of pliers 12 is manipulated. The handle 14 of a respective one of the pliers 12 has a slot 22 integrated therein and the pivot point 20 is slidable along the slot 22. In this way the distance between the jaw 16 associated with each of the pliers 12 can be adjusted. The pair of pliers 12 may comprise a pair of channel lock pliers or other type of pliers that has an adjustable width.

A pair of members 24 is provided and each of the members 24 is coupled to the jaw 16 associated with a respective one of the pliers 12. Additionally, each of the members 24 is oriented to extend in opposite directions from each other. Each of the members 24 has a first end 26, a second end 28 and an outer surface 30 extending therebetween, and the outer surface 30 has a top side 32 and a bottom side 34. The bottom side 34 of the outer surface 30 of each of the members 24 is coupled to the distal end 18 of the jaw 16 associated with the respective pliers 12 at a point that is located adjacent to the first end 26 of the members 24. Each of the members 24 is oriented to extend along a line that is oriented perpendicular to a longitudinal axis of the jaw 16 associated with the respective pliers 12. Additionally, the first end 26 of each of the members 24 is directed toward each other, and each of the members 24 may have a length ranging between approximately 1.0 inches and 2.0 inches.

A pair of grips 36 is provided and each of the grips 36 is coupled to a respective one of the members 24. Each of the grips 36 has a slot 38 extending therethrough to accommodate a conductor 40 of a respective one of a pair of solar panel connectors 42 having the solar panel connectors 42 being positioned between the grips 36. Each of the solar panel connectors 42 may be an MC4 connector that is commonly employed on photovoltaic panels for daisy chaining the photovoltaic panels together. Each of the grips 36 is urged toward each other when the pair of pliers 12 is manipulated into a closed position to compress the solar panel connectors 42 into a connected condition.

Each of the grips 36 has a first surface 44, a second surface 46 and an outer edge 48 extending therebetween. The outer edge 48 of each of the grips 36 is continuously arcuate about a center point of the grips 36 such that each of the grips 36 has a disk shape. Each of the grips 36 has a hole 50 extending through the first surface 44 and the second surface 46, and the hole 50 is centrally positioned on the grips 36. The slot 38 in each of the grips 36 extends between the outer edge 48 and the hole 50. Each of the grips 36 may have a diameter ranging between approximately 0.5 inches and 1.0 inch.

The outer edge 48 of each of the grips 36 is coupled to the top side 32 of the outer surface 30 of the respective member 24. Additionally, the first surface 44 of each of the grips 36 is directed toward each other. Each of the grips 36 is oriented such that the slot 38 in each of the grips 36 extends along an axis that is oriented perpendicular to the top side 32 of the outer surface 30 of the respective member 24. Moreover, each of the grips 36 is positioned adjacent to the second end 28 of the respective member 24.

In use, the pair of pliers 12 is adjusted to a width sufficient to facilitate the solar panel connectors 42 to be positioned between each of the grips 36 having each of the conductors 40 on the solar panel connectors 42 being inserted into the slot 38 in a respective grip. The pair of pliers 12 is manipulated into a closed position such that the pair of grips 36 is urged toward each other. In this way the solar panel connectors 42 are compressed between the pair of grips 36 to engage each other in a connected condition. Moreover, the pliers 12 ensure that the solar panel connectors 42 are fully seated together when the solar panel connectors 42 are connected.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A connector tool assembly for connecting solar panel connectors together, said assembly comprising:
a pair of pliers, each of said pair of pliers comprising a handle and a jaw, said handle each of each of said pair of pliers being pivotally coupled together at a pivot point thereby facilitating said jaw associated with each of said pair of pliers to be urged toward or away from each other when said handle of each of said pair of pliers is manipulated, said handle of a respective one of said pliers having a slot being integrated therein, said pivot point being slidable along said slot thereby facilitating the distance between said jaw associated with each of said pliers to be adjusted;
a pair of members, each of said members being coupled to said jaw associated with a respective one of said pliers, each of said members being oriented to extend in opposite directions from each other; and
a pair of grips, each of said grips being coupled to a respective one of said members, each of said grips having a slot extending therethrough wherein said slot in each of said grips is configured to accommodate a conductor of a respective one of a pair of solar panel connectors having the solar panel connectors being positioned between said grips, each of said grips being urged toward each other when said pair of pliers is manipulated into a closed position wherein each of said grips is configured to compress the solar panel connectors into a connected condition.

2. The assembly according to claim 1, wherein:
said jaw associated with each of said pliers has a distal end; and
each of said members has a first end, a second end and an outer surface extending therebetween, said outer surface having a top side and a bottom side, said bottom side of said outer surface of each of said members being coupled to said distal end of said jaw associated with said respective pliers at a point being located adjacent to said first end of said members.

3. The assembly according to claim 2, wherein each of said members is oriented to extend along a line being oriented perpendicular to a longitudinal axis of said jaw associated with said respective pliers, said first end of each of said members being directed toward each other.

4. The assembly according to claim 1, wherein each of said grips has a first surface, a second surface and an outer edge extending therebetween, said outer edge of each of said grips being continuously arcuate about a center point of said grips such that each of said grips has a disk shape, each of said grips having a hole extending through said first surface and said second surface, said hole being centrally positioned on said grips, said slot in each of said grips extending between said outer edge and said hole.

5. The assembly according to claim 4, wherein:
said jaw associated with each of said pliers has a distal end;
each of said members has a first end, a second end and an outer surface extending therebetween, said outer surface having a top side and a bottom side, said bottom side of said outer surface of each of said members being coupled to said distal end of said jaw associated with said respective pliers at a point being located adjacent to said first end of said members, each of said members is oriented to extend along a line being oriented perpendicular to a longitudinal axis of said jaw associated with said respective pliers, said first end of each of said members being directed toward each other; and
said outer edge of each of said grips being coupled to said top side of said outer surface of said respective member, said first surface of each of said grips being directed toward each other.

6. The assembly according to claim 5, wherein each of said grips is oriented such that said slot in each of said grips extends along an axis being oriented perpendicular to said top side of said outer surface of said respective member.

7. A connector tool assembly for connecting solar panel connectors together, said assembly comprising:
a pair of pliers, each of said pair of pliers comprising a handle and a jaw, said handle each of each of said pair of pliers being pivotally coupled together at a pivot point thereby facilitating said jaw associated with each of said pair of pliers to be urged toward or away from each other when said handle of each of said pair of pliers is manipulated, said handle of a respective one of said pliers having a slot being integrated therein, said pivot point being slidable along said slot thereby facilitating the distance between said jaw associated with each of said pliers to be adjusted, said jaw associated with each of said pliers having a distal end;
a pair of members, each of said members being coupled to said jaw associated with a respective one of said pliers, each of said members being oriented to extend in opposite directions from each other, each of said members having a first end, a second end and an outer surface extending therebetween, said outer surface having a top side and a bottom side, said bottom side of said outer surface of each of said members being coupled to said distal end of said jaw associated with said respective pliers at a point being located adjacent to said first end of said members, each of said members being oriented to extend along a line being oriented perpendicular to a longitudinal axis of said jaw associated with said respective pliers, said first end of each of said members being directed toward each other; and
a pair of grips, each of said grips being coupled to a respective one of said members, each of said grips having a slot extending therethrough wherein said slot in each of said grips is configured to accommodate a conductor of a respective one of a pair of solar panel connectors having the solar panel connectors being positioned between said grips, each of said grips being urged toward each other when said pair of pliers is manipulated into a closed position wherein each of said grips is configured to compress the solar panel connectors into a connected condition, each of said grips having a first surface, a second surface and an outer edge extending therebetween, said outer edge of each of said grips being continuously arcuate about a center point of said grips such that each of said grips has a disk shape, each of said grips having a hole extending through said first surface and said second surface, said hole being centrally positioned on said grips, said slot in each of said grips extending between said outer edge and said hole, said outer edge of each of said grips being coupled to said top side of said outer surface of said respective member, said first surface of each of said grips being directed toward each other, each of said grips being oriented such that said slot in each of said grips extends along an axis being oriented perpendicular to said top side of said outer surface of said respective member, each of said grips being positioned adjacent to said second end of said respective member.
